(19) United States
(12) Patent Application Publication
(10) Pub. No.: US 2022/0251481 A1
(43) Pub. Date: Aug. 11, 2022

(54) ELECTRICAL DEVICE, SYSTEM, AND METHOD FOR CONVERTING SOAP PARTS INTO A BAR OF SOAP OR LIQUID SOAP

(71) Applicant: Robert E. Burks, JR., Laurel, MD (US)

(72) Inventor: Robert E. Burks, JR., Laurel, MD (US)

(21) Appl. No.: 17/666,229

(22) Filed: Feb. 7, 2022

Related U.S. Application Data
(60) Provisional application No. 63/200,008, filed on Feb. 9, 2021.

(51) Int. Cl. C11D 9/26; C11D 17/00; C11D 9/04; C11D 9/44; C11D 13/22; C11D 13/10; C11D 13/18

(52) U.S. Cl. CPC C11D 9/265; C11D 17/0047; C11D 9/262; C11D 13/18; C11D 9/442; C11D 13/22; C11D 13/10; C11D 9/045

(57) ABSTRACT

Electrical devices for converting soap parts into bar soap or liquid soap including hopper for receiving the soap parts; means for increasing surface area of the soap parts by producing soap chips, the means for increasing the surface area being in communication with the hopper; mixing vessel for receiving the soap chips and forming a liquid soap mixture, the mixing vessel comprising means of agitation; liquid reservoir in fluid communication with the mixing vessel; ingredients reservoir in fluid communication with the mixing vessel; control unit having one or more processors; and non-transitory memory operatively coupled to the one or more processors comprising a set of instructions executable by the processors to cause the one or more processors to control various functions of the electrical device. The disclosure also relates to methods and systems for making bar soap and/or liquid soap using the machines and solutions for doing the same.

### REFERENCE TO RELATED APPLICATIONS

This application claims an invention which was disclosed in U.S. Provisional Application No. 63/200,008, filed Feb. 9, 2021, entitled “Electrical Device for Converting Soap Parts into a Bar of Soap or Liquid Soap”. The benefit of priority under 35 USC § 119(e) of the United States provisional application is hereby claimed, and the aforementioned application is hereby incorporated herein by reference.

### FIELD

Exemplary embodiments relate to soap making, and more particularly to an electrical device, systems, and methods for converting soap parts into one or more bars of soap or liquid soap.

### BACKGROUND

Over the course of many baths, showers, and hand washes, people can accumulate many tiny soap parts. Some recourses have been to melt them down, watch them accumulate in a pile in a random corner, or throw them away. Used soap bars create millions of pounds of waste in landfills each year, which increases waste and pollution and wastes money.

Previous means of recycling soap parts include: 1) melting them in a pot on a stove and molding them into shape, or 2) collecting them into small bags used to form lather and scrub the body. Melting soap parts and molding them into a bar or producing liquid soap may be a tedious process that requires certain amounts of time, patience, and chemistry skills. Moreover, many people are too busy to employ a stove top melting and mixing procedure regularly.

Small bags used to collect soap parts often do not hold the chips inside or fall apart after limited use. Many have expressed dissatisfaction with the size, quality, and price of small bags used to collect soap parts.

Exemplary embodiments, as described below, may address some of the above-mentioned problems.

### SUMMARY

This section provides a general summary of the disclosure, and is not a comprehensive disclosure of its full scope or all of its features.

In some aspects, the disclosure concerns a device for converting soap parts into bar soap or liquid soap mixture, the device comprising: a hopper for receiving the soap parts; means for increasing surface area of the soap parts by producing soap chips, the means for increasing the surface area being in communication with the hopper and at least some of the soap chips being smaller in size than the soap parts; mixing vessel for receiving the soap chips and forming a liquid soap mixture, the mixing vessel comprising a means of agitation; liquid reservoirs in fluid communication with the mixing vessel; ingredients reservoir in fluid communication with the mixing vessel; a control unit having one or more processors; and a non-transitory memory operatively coupled to the one or more processors comprising a set of instructions executable by the one or more processors to cause the one or more processors to control one or more of the hopper, the means for increasing surface area, the mixing vessel, the means for agitation, and the ingredients reservoir.

In other aspects, the disclosure concerns methods of forming a bar of soap from soap parts in a device, the method comprising: by the device, grinding, cutting, or shredding the soap parts to produce soap chips; by the device, contacting the soap chips with a predetermined amount of glycerin and a humectant other than glycerin to produce a soap mixture; by the device, mixing and heating the soap mixture to produce a blended soap mixture; and by the device, heating, compressing, and molding the blended soap mixture into a soap bar, wherein the soap mixture comprises about 28 wt % to about 96 wt % soap and about 0 to about 70 wt % glycerin.

In yet another aspect, the disclosure concerns method of forming liquid soap from soap parts in a device, the method comprising: by the device, grinding, cutting, or shredding the soap parts to produce soap chips; by the device, contacting the soap chips with a predetermined amount of water, glycerin, and humectant other than glycerin to produce an aqueous soap mixture; by the device, heating the aqueous soap mixture; and by the device, mixing the aqueous soap mixture to produce a blended soap mixture; wherein the aqueous soap mixture comprises about 1 wt % to about 5 wt % soap chips, about 30 wt % to about 92 wt % water and about 0 wt % to about 60 wt % glycerin.

Further aspect of the disclosure concern solutions for combining with soap chips to form a soap mixture comprising about 87 wt % to about 91 wt % of glycerin; about 7 wt % to about 12 wt % of sorbitol; about 2 wt % to about 4 wt % of a preserving agent; and about 0 wt % to about 2 wt % of fragrance.

### DRAWINGS

The present teachings will become more fully understood from the detailed description and the accompanying drawings, wherein:

FIG. 1 is a schematic view of an exemplary embodiment comprising a top module, mixing module, formative module, and an ejection module.

FIG. 2 is a schematic view of an exemplary embodiment comprising (1) a top module, (2) liquid reservoirs, (3) s mixing module, (4) a forming module, (5) an ejection module, (6) a soap bar mold, (7) a soap mold housing, (8) a waste tank, (9) a first ingredients reservoir, and (10) a second ingredients reservoir.

FIG. 3 is a schematic view of an exemplary embodiment including a cartridge heater, mixing module service door and a cooling fan.

FIG. 4 is a schematic view of an exemplary embodiment comprising a, liquid reservoir, fluid pump, paddle mixer, waste tank, soap mold housing, soap blade array and a soap blade die.

FIG. 5 is a schematic view of an exemplary embodiment comprising a chopper motor, fluid pump and a cartridge heater.

FIG. 6 is a schematic view of a portion of one example of a mixing module including a liquid soap motion sensor, a weight sensor, a liquid soap dispenser nozzle, a cooling channel, a bar soap fill nozzle and the body of the mixing module.

FIG. 7 is a schematic view of some electronic aspects of an exemplary embodiment comprising a control module, data store(s), I/O hub, sensor module, and actuator(s).

FIG. 8 is a schematic view of some electronic aspects of another exemplary embodiment comprising processor(s) and data store(s) connected to a network which is connected to a control module.

FIG. 9 is a schematic view of some electronic aspects of yet another exemplary embodiment.

FIG. 10 presents graphs representing glycerin vs sorbitol concentration.

FIG. 11 presents graphs representing glycerin concentration vs mass ratio with total liquid.

Reference herein to details of the illustrated embodiments is not intended to limit the scope of the claims.

### DESCRIPTION

The following detailed description is not to be taken in a limiting sense, but is made merely for the purpose of illustrating the general principles of exemplary embodiments.

In an exemplary embodiment, there is provided a tabletop electrical or battery-operated device for converting soap parts into a bar of soap or liquid. The device may be constructed and arranged to receive and accept deposits of soap parts and other ingredients. The device may be capable of griding, chipping or shredding soap parts into tiny fragments that are mixed with other ingredients together into a mixture, and then molding the resulting mixture into a bar of soap or dispensing it in liquid form.

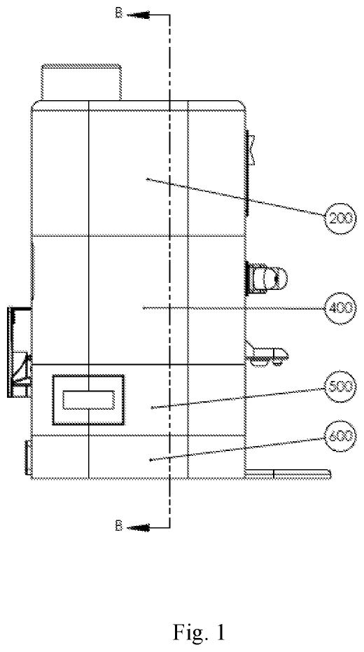

Referring to FIG. 1, the figure shows one basic device comprising a top module 200, mixing module 400, forming module 500 and an ejection module 600. The top module 200 serves as a receiving point for soap parts as well as including the chopping, grinding, or shaving of the soap parts function. The second module or mixing module 400 comprises a mixing vessel to mix the soap ingredients. The third module or forming module 500 provides for the formation of a soap bar. The fourth module or ejection module 600 functions to discharge a formed soap bar from the device.

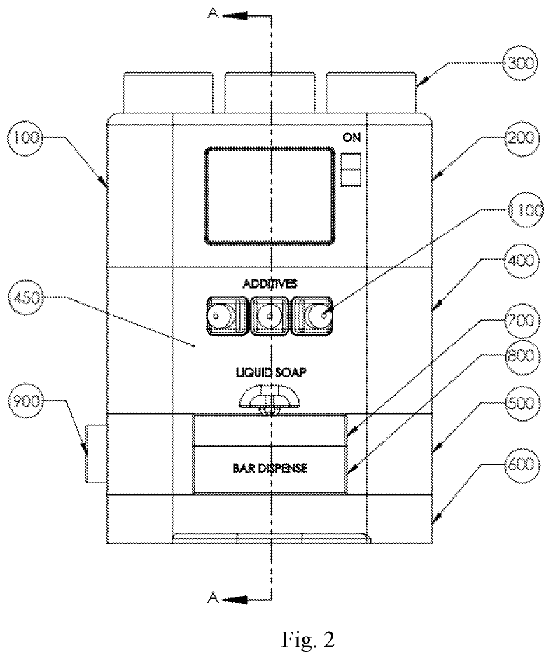

FIG. 2, in accordance with one exemplary embodiment showing additional detail from FIG. 1. The embodiment of FIG. 2 shows the soap making device 100 comprising (1) a top module 200, (2) liquid reservoirs 300, (3) s mixing module 400, (4) a forming module 500, (5) an ejection module 600, (6) a soap bar mold 700, (7) a soap mold housing 800, (8) a waste tank 900, (9) a first ingredients reservoir 1000, and (10) a second ingredients reservoir 1100.

The first module or top module 200 is where the soap parts may be inserted. In addition, there are ingredient bottles that may be inserted into the cylindrical holes of the module. There may be a touch screen and other buttons (on/off, for example) on the top module 200. The housing of this module may be made of injection molded plastic such as acrylonitrile butadiene styrene (ABS), nylon, polyethylene (PE), or other suitable polymeric material.

The second module that is located below the top module 200 is the mixing module 400 including a mixing vessel. In a non-limiting embodiment, the second module may be located directly below the top module 200. In the second module, all ingredients come together in a mixing vessel 450 Heat and mixing will be utilized to create the desired product. The ingredients may be a solid bar soap recipe or a liquid hand soap recipe. Additives may be added to the soap recipe within the module. In some embodiments, the additives may be added using one or more ingredient reservoirs and 1100 that dispense liquid drops into the mixing vessel manually or in an electronically controlled manner. In some embodiments, one or more of water, glycerin and mineral oil ingredient reservoirs are utilized. The mixing vessel should be made of a material that is high temperature compatible, chemically resistant to all ingredients, and has a high surface lubricity to prevent soap products from getting stuck to the walls of the vessel. In some embodiments, the mixing vessel may be a stainless steel, or carbon steel with polytetrafluoroethylene (PTFE) coating. The mixing vessel, in some embodiments, may be a stamped sheet-metal part that is manufactured using a high-volume stamping tool.

The mixing module 400 may comprise a paddle mixer 1700 or an ultrasonic mixing unit. The paddle mixer 1700 is located in the mixing vessel. The paddle mixer 1700 may be driven by an electrical motor to achieve active mixing of the soap ingredients. The paddle mixer 1700 may be metal, ceramic or plastic. It is important for the paddle mixer 1700 to be high temperature compatible and have a high-lubricity surface. High lubricity is so material does not stick to the paddle mixer 1700 surface. With an ultrasonic mixing unit, the unit may provide acoustic vibrations within the mixing module 400.

In certain embodiments, the minimum mixing vessel size to accommodate the mixing apparatus and solutions is 300 mL to 1000 mL or, in some embodiments, 500 mL (17 fluid ounces). In some embodiments, the chamber can be made of stainless steel to address the high temperature cycling issues.

When heating the soap mixture with water and/or glycerin, foaming may occur. While not wanting to be bound by theory, the foaming is believed to be due to the amount of air contained in the small soap chips. With proper continuous stirring, the foaming effect is significantly decreased. In some embodiments slow speed stirring (20 rpm, for example) is employed.

The third module is the forming module 500. In some embodiments, the forming module 500 is provided below the second module. In a non-limiting embodiment, the third module is provided directly below the second module. In some embodiments, the mixing vessel 450 is in fluid communication with a soap conduit and a soap mold 700. The bar soap may be molded in the forming module 500. Heated bar soap recipes may be injected into a bar mold 700, and cooled. In certain embodiments, the cooling may be performed using electric fan(s) and/or aluminum heatsink(s). The forming module 500 may comprise a drip tray, which is used to collect waste from flushing cycles.

One cost-effective polymer material suitable for the soap bar mold 700 is acrylonitrile butadiene styrene (ABS). The molds may be made by any suitable method including injection molding or 3D printing techniques. Other suitable materials for the soap bar mold 700 are polycarbonate and metal. One suitable metal is cast aluminum. Cooling fans may be employed to improve cooling times of the mold.

The fourth module is the ejection module 600 that is provided below the forming module 500. In a non-limiting embodiment, the fourth module may be provided directly below the forming module 500. The ejection module 600 is the base of the soap machine. This module may have a mechanism that will eject the finished and cooled bar of soap. There is also a drip tray in this module to catch any drips during liquid soap dispensing.

As discussed above, the modular soap machine may comprise ingredient bottles. The ingredient bottle(s) may plug into the top module 200, and will dispense ingredients into the mixing vessel. The bottles may be made of polyethylene or other suitable material, and may be blow molded or injection molded. There can be a flow sensor or similar device to measure the amount of liquid dispensed from each bottle.

In addition to the ingredient bottle(s), one or more additive bottles may be utilized. In some embodiments, there are up to three additive bottles to allow liquid additives to be included in soap formulas. The additive bottle dispenses liquid drops into the mixing vessel manually or in an electronically controlled manner. The operator can press the bulb to dispense liquid, similar to a primer bulb on a lawnmower engine. The body of the additive bottle may be made from polyethylene (PE), high-density polyethylene (HDPE), acrylonitrile butadiene styrene (ABS), polycarbonate or similar injection molded plastic. In some embodiments, the ingredient and additive bottles may comprise or be fluidly connected to a primer bulb. The primer bulb may be made of rubber, silicone, or similar pliable material. The primer bulb can be over-molded onto additive body parts. Alternatively, the liquid in the additive bottle may be dispensed by an electrical pump.

In one embodiment, the device may further comprise a device housing in which all of these elements are held and retained. In another embodiment, the device further comprises a power on/off button, and a plurality of device settings for operating the components of the device.

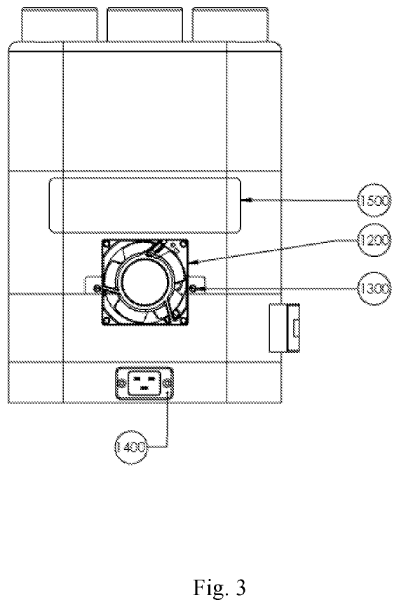

Turning now to FIG. 3, the device may further comprise one or more of a heater 1300, IEC connector 1400, service door 1500 and a cooling fan 1200. The depicted heater 1300 may function to assist with the dissolving process of the soap chips within the mixing module 400. The device may optionally comprise a service door 1500 to allow access to mixing module 400 for maintenance and/or cleaning. A cooling fan 1200 may also be included in the device. The cooling fan 1200 may serve to maintain a safe temperature on the outside of the device and/or to cool a formed liquid soap or bar soap.

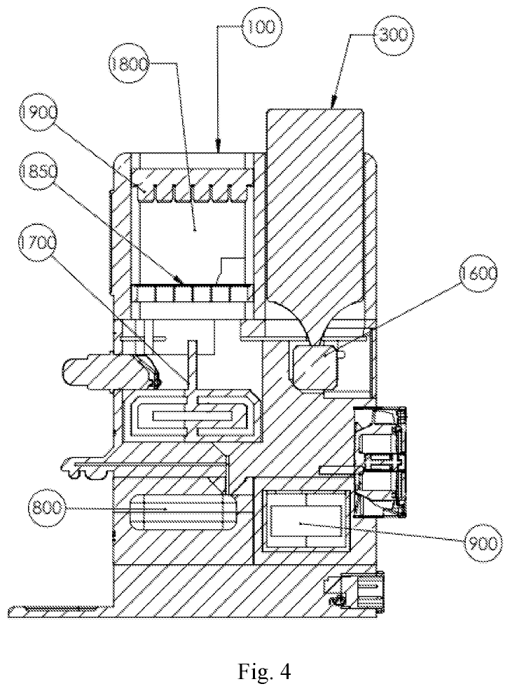

FIG. 4 shows features of one embodiment of the soap making device 100 including liquid reservoir 300, fluid pump 1600, soap mold housing 800, paddle mixer 1700, waste tank 900, means for increasing surface area 1800 (such as a soap blade array 1850 and soap blade die 1900). In some embodiments, the means for increasing surface area 1800 is a soap chopper, shredder, grinder or die and blade array may reside within the first chamber or external to the soap machine. The chopper may create uniform soap chips from the various sized soap parts that are inputted into the system. The resulting soap chips have a higher surface area than the original soap parts. In some embodiments, the soap chopper has two parts, the die, and the blade array. The die may have a grid patterned blade that creates an array of predetermined shapes. In some embodiments the shape is a rectangle or square. In one embodiment, the shape is ¼ to ¾ inch squares. In certain embodiments the shape is ½ inch squares. Other shapes such as rectangles or other appropriate shapes may be utilized. The die has a shape that fits over the blade array. After the soap parts are inputted into the machine, the die will be forced down and press the soap through the blade array. The die may be forced down manually or by an electronic processing signal.

One or more pumps, such as fluid pump 1600, serve to move one or more of liquid from the liquid reservoir 300 to the mixing vessel, ingredients from the ingredients reservoir to the mixing vessel, and contents from the mixing vessel. In addition, the soap making device 100 may comprising a waste tank 900 to collect any drippings or other waste produced during the operation of the device.

In some embodiments, the fluid pump 1600 may circulate cleaning fluid through the system to clean the internals of the soap making machine 100. Cleaning fluid will come from the liquid reservoirs and will end up in the waste tank 900 once the cleaning cycle is complete. An electric motor may be used to power a small pump to force fluid through a series of tubes or pipes in the machine. A spray nozzle may be utilized to clean the soap chip area. In some embodiments, fluid pumps 1600 may be a diaphragm pump, centrifugal pump, positive displacement pump or any other pump suitable for use in the device or method of making the soap bar or liquid soap.

Design considerations may include the device cleaning and sanitation of the device. A cleaning cycle for the device may use mineral oil heated to 160° C. recycled through the machine several times. The high temperature of this mineral oil wash may be bacteria killing given enough contact time with surfaces. Additionally, sanitary soap solutions can be maintained as output from this device, by inclusion of a liquid growth inhibitor such as, for example, Leucidal® Complete, a preservative marketed by Active Micro Technologies in the glycerin solution.

In one or more embodiments, the soap making device may be sanitized by the recirculating high temperature mineral oil bath. The sanitizing may be performed by lifting the soap remnants off the surfaces of any components within the device. Additionally, because the mineral oil lifts the soap from surfaces, any small passages in the final device may be cleared of soap deposits. Such deposit displacing cleaning method may prolong the life cycle of the end device and minimize the required maintenance.

The soap making device 100 of FIG. 4 also comprises a soap mold housing 800. The soap mold housing 800 may contain a soap mold that functions to provide a mold for making soap of a desired size and shape. The soap mold may be rectangular, oval or any other desirable shape. In some embodiments, the soap mold may comprise a top and a bottom portion that may separate to facilitate release of the formed soap bar. The soap bars produced according to an exemplary embodiment may have, for example, a minimum size of about 2.0 oz and a maximum size of about 3.5 oz. In other embodiments, the soap bar may be about 2.5 oz to about 3.2 oz or about 2.6 oz to about 3.0 oz.

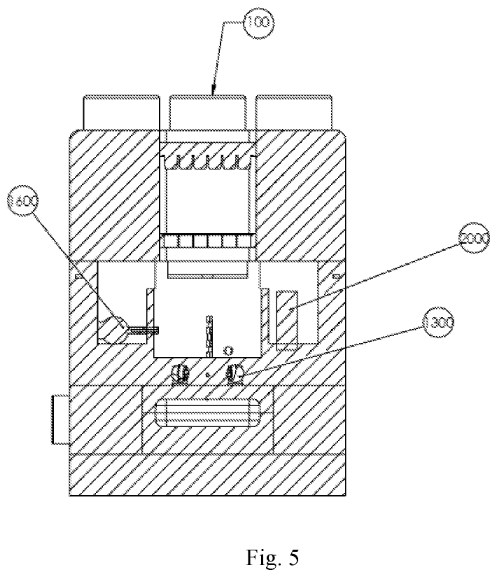

FIG. 5 shows features of one embodiment of the soap making device 100 including a chopper motor 2000, fluid pump 1600 and a heater 1300. The chopper motor 2000 may be used when a chopper is utilized to convert soap parts to soap chips. One or more fluid pumps 1600 may move liquid ingredients that form the liquid soap or bar soap. The heater 1300 may serve to heat the soap mixture to improve dissolution of the soap chips.

In certain embodiments, the device has an electrical operation system comprising the power on/off button, and the plurality of device settings buttons, operably connected with a printed circuit board, and a motor, an air pump, a heater 1300, and a fluid pump 1600.

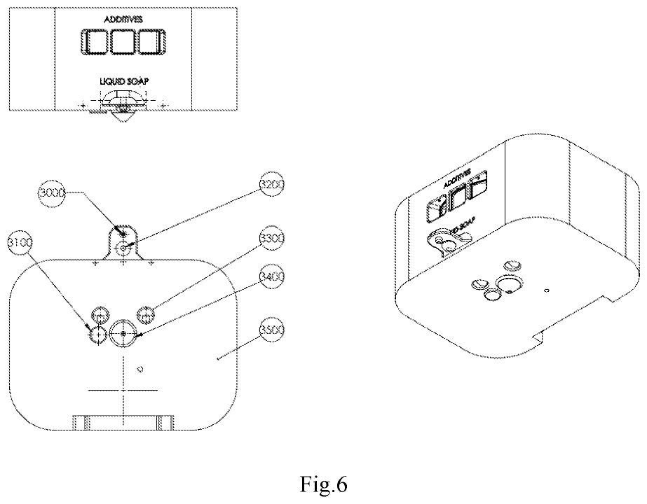

FIG. 6 shows some features of one embodiments of the mixing module 400 including a liquid soap motion sensor 3000, a weight sensor 3100, a liquid soap dispenser nozzle 3200, a cooling channel 3300, a bar soap fill nozzle 3400 and the body 3500 of the mixing module 400. The liquid soap motion sensor 3000 senses the presence of a hand below the liquid soap dispenser nozzle 3200 and triggers release of a portion of liquid soap through the liquid soap nozzle 3200. The weight sensor 3100 can determine the amount of soap chips in the mixing module to allow the machine to determine the amount of ingredients needed to prepare the desired formulation. The weight sensor 3100 may also be used to determine the amount of the contents removed from the mixing module after mixing. The cooling channel 3300 facilitates cooling of the contents of the mixing module. The bar soap fill nozzle 3400 serves to allow liquid soap to fill the soap mold for formation of bar soap.

In one exemplary embodiment, the device may be operated and may operate by a process including one or more of the following steps and combinations thereof:
1. A predetermined quantity of soap parts may be placed in the device. A weight sensor may be included in the design to assist in determining the amount of soap parts.
2. A device grinding/cutting/shredding function may be activated.
3. A predetermined amount of hot water may be measured and supplied from the water reservoir. The water may be conveyed to the mixing vessel.
4. A device heating function may be initiated.
5. Additional and/or optional ingredients (as needed or desired) may be added from the ingredients reservoir.
6. A device agitation function may be initiated.
7. A soap mixture may be heated, compressed, and molded into a soap bar, or it may be dispensed in liquid form.
8. The soap bar may be moved to a discard area or liquid soap to a dispensing area.

In an exemplary embodiment, the elements of the process may be interrelated in the following manner. In some embodiments of the process, the step 2 grinding/cutting/shredding function may be an important component of a process if a user has provided chips of soap. However, the device may be used to mix liquid ingredients as well. In certain embodiments of the process, device settings may allow the process to bypass the grinding/cutting function if desired, and commence a soap making at step 5 by adding ingredients as the first step. This will ensure that all additional ingredients are flushed into the mixing vessel. The process, at step 6, may comprise a mechanism stirring the contents while the device optionally vibrates the tray to ensure consistency throughout the mixture. In certain embodiments of the process, in step 7, the mixing vessel may be heated and compressed so that the soap mixture may be slowly compressed to the desired size. The process may, at step 8, eject the soap bar into the discard or dispensing area.

In an exemplary embodiment, the device may function in the following manner. The soap parts and other ingredients may be placed into the device. When the device is closed and activated the device grinding/cutting/shredding function may operate to reduce the chips into shredded soap pieces and may deposit the shredded soap pieces into a mixing vessel 450. A measured amount of hot water or glycerin may be added from the first ingredients reservoir 1000. Additional ingredients may be added to the tray (as needed or desired) from the second or third ingredients reservoir 1100. The contents may be heated for melding of the soap composition into a bar of soap. The device mixing/churning function may be initiated to achieve consistency throughout the mixture. The device may continue to heat the soap mixture as it slowly compresses into a soap bar or the liquid soap is emptied from the tray into the dispensing area. The soap bar may then be moved to a discard area of the ejection module 600.

The soap making device 100 may include different operating modes/settings, each of which capable of being activated using digital or mechanical buttons provided at the device. The digital buttons may be provided on a digital display on the device or a mechanical button may be provided on the device. Depressing the digital or mechanical button may activate a particular setting mode. In some embodiments, the soap machine is a modular product.

In some machines there are four main modules (top module 200, mixing module 400, forming module 500, and ejection module 600) that are assembled to become the complete device. The modular nature allows for easy replacement of replacement parts. In addition, the modular nature allows for adding additional modules in future designs.

Processing temperatures and compositions may vary between production of liquid soap and bar soap. With liquid soap, the operational temperature range is about 80° C. to about 100° C. with a temperature of about 90° C. in some embodiments. With production of bar soap, the operational temperature range is about 150° C. to about 170° C. with a temperature of about 160° C. in some embodiments.

With liquid soap, in an exemplary embodiment, the amount of soap may be about 1 wt % to about 5 wt % of the liquid soap composition, with an amount of about 4.8 wt % in some embodiments. The amount of water in the liquid soap is about 30 wt % to about 92 wt % with an amount of about 92 wt % in some embodiments. Glycerin may be added as an additive in an amount of about 0 wt % to about 60 wt % with an amount of about 5 wt % to about 6 wt % in some embodiments. Fragrance and/or other additives may be added in an amount of about 0 wt % to about 10 wt % with an amount of 0 wt % to about 2 wt % in some embodiments.

While soap bars are soluble in water, soapy water cleans but does not have the feel and viscosity of common liquid hand soaps. Common liquid hand soaps have a gel consistency which the liquid soap product output by this device may mimic. Much experimentation has determined that many ratios of solid soap parts-to-liquid result in a gel with the consistency of cured gelatin. Further experimentation has identified a solid soap parts-to-liquid ratio with additives which does not gel with most soap bars (about 0.005 to about 0.02 or about 0.01 g soap per gram total liquid in some embodiments).

For production of bar soap, the amount of soap is about 28 wt % to about 96 wt % of the bar soap with an amount of about 95 wt % in some embodiments. An amount of glycerin ranging from about 0 wt % to about 70 wt % with an amount of about 3 wt % to about 7 wt % in some embodiments. Fragrance and/or other additives may be added in an amount of about 0 wt % to about 10 wt % with an amount of 0 wt % to about 2 wt % in some embodiments.

A broad range of mass ratios (grams of soap/grams of liquid) for bar soap ranges from 0.4:1 to 25:1 was studied. At the low end of mass ratios, the result was a viscous gel which is not suitable for a soap bar. At the high end of the ratios studied the bar is very firm, but risks the soap being overheated and having a burned smell from the caramelization of the sugars in the mixture. At the 25:1 mass ratio, it may be difficult to dissolve the soap chips quickly and completely. In some embodiments, the recommended mass ratio is 20:1 to 15:1 or, in other embodiments, 18:1 grams of soap per gram glycerin (94.7 wt %). This ratio may produce a consistent commercial feeling bar regardless of the type of chips placed into the device, including mixed bar types.

Differences exist between the liquid and bar soap types. One of the most significant is the viscosity. With most liquid hand soaps, there is a gel consistency while some liquid dish detergents are much “thinner.” Some liquid dish soaps are less viscous so that they dissolve quickly in a sink full of water to begin cleaning on contact with a dirty dish. Even these thinner dish soaps are viscous enough to stay on the palm of the hand while scrubbing. The early experimental results did dissolve the soap chips but left a very thin (non-viscous) product behind which is not like common hand-soaps. Soap chips to liquid processing relies very heavily on the specific additives already present in some starting bars but not others. The widely varied composition of the soap bars makes available means that some contain polymers like those found in detergents and dish soaps. Depending on the types of bars, they may also contain sugar (such as sucrose which is common table sugar) or sugar-like molecules known for their ability to hold onto water. These sugar-like molecules are known as humectants which are used for holding onto water and hydrating the skin. These compounds contribute to nicer skin-feel of a bar when used and are difficult to assess quantitatively. This also means that many different mass ratios have the potential to have polymer interactions which change their viscosity significantly.

With solid soap parts-to-bar conversion, glycerin may be used as the one of the primary solubilizing agents for liquid soap conversion. Unlike solid soap parts-to-bar processing, most of the liquid phase (greater than 90%) is water and thus the term total liquid will describe the solvent phase. As with solid soap parts-to-bar compositions, the larger the mass ratio, the lower the total liquid content. The lower the total liquid content, the more difficult it is to get all the soap chips to dissolve. The mass ratio values above 0.05:1 (4.8 wt %) were found to gel with sufficient viscosity that it cannot be easily pumped or transferred when cooled back down to room temperature. Pure bar solutions behave much more predictably and therefore could have a customizable setting in the finalized device to obtain the desired liquid soap consistency. The device may be designed for the case where at least 2 different bar types may be present in the mixing vessel.

Widely varied bar compositions are to blame for the non-trivial chemistry involved in the solid soap parts-to-liquid process. In the solid soap parts-to-bar process, interactions between polymers, detergents and catalysts are masked by the solid nature of the ending bar. In the case of these soap bars, certain combinations such as citric acid (vitamin C) and sorbitol are able to polymerize regardless of other surfactants and polymers which may also be present in the bar. The soap solution dissolves quickly at 90° C., which when cooled to near room temperature has a hand soap-like viscosity which can be pumped as hand soap.

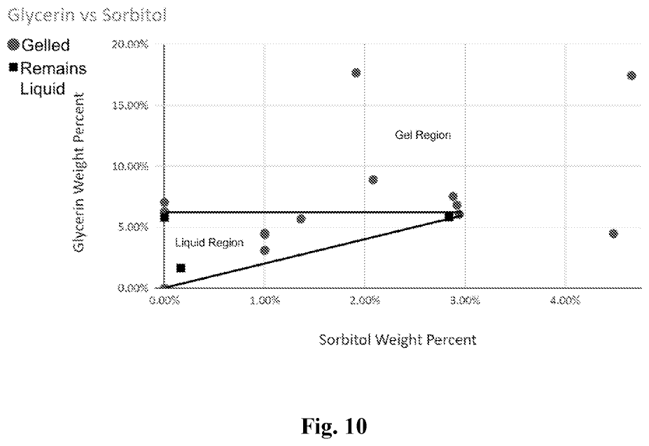

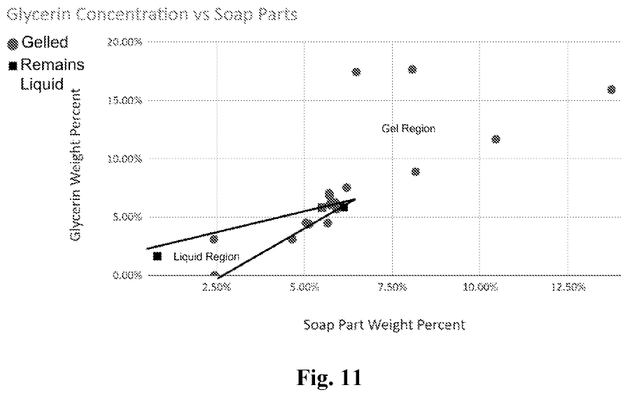

The clear control experiment would be at the same mass ratio to eliminate the sorbitol which should resolve the gelation problems for the liquid soap. This was not the expected result, as the mass ratio of 0.025:1 (2.4 wt %) with no glycerin and no sorbitol produced the same gel with certain bars such as Irish Spring. The polymerization observed for certain bar types may be related to the presence of hydrogenated tallow acid. Hydrogenation of fatty acids often leads to increased viscosity or even solidification at room temperature. This is how non-dairy butter substitutes are made, starting from oil, and ending with room temperature solids. The estimated regions of best operation are depicted on the graphs in FIGS. 10 and 11. In the FIGS. 10 and 11, circles represent compositions that gelled and squares represent compositions that remained liquid. In FIGS. 10 and 11, the triangular region within which gelled solutions can be easily reliquefied with agitation or shaking. The viscosity will change based on which brands of soap bars were used for the solution, but within that region the general output is a recognizable liquid hand soap.

In some embodiments, a ratio of about 0.005 to about 0.02 or about 0.01:1 g soap per gram of total liquid (1 wt %) for the general case of unknown bar types is recommended. The recommended ratio for best viscosity and hand soap-like feel is 0.05:1 and to be placed in a squeeze bottle rather than a pump bottle. Additionally, the 0.05:1 ratio preserves much of the character of the original bar. Specifically Dove bars, at the 0.05:1 ratio produced the subjectively ‘nicest’ of the hand soaps from the solid soap parts-to-liquid study.

Choice of additives used for the soap affects the feel of the liquid soap in use, whereas the total mass ratio is important for the mechanical properties of the liquid. When simply dissolving the bar soaps in water with some glycerin, the soaps often leave a rubber-like skin feeling similar to washing with many bar soaps. Ingredients may include one or more humectants. Suitable humectants include but are not limited to polyols such as glycerol sorbitol, propylene glycol and polyethylene glycols. Other ingredients or additives may comprise water, preserving agent, fragrance, and colorant. The humectant behavior of sorbitol means it retains water when it contacts the skin, helping to preserve the moisture in the skin. This is similar in effect to what glycerin naturally does because of its humectant nature.

Several ratios of sorbitol to glycerin were studied: 0 to 93% sorbitol in the total liquid phase. At the high ratios of 90-93% sorbitol, the resulting soaps left a sticky residue on the hands after washing. By contrast the lowest end of 0% sorbitol brought back the rubbery skin feeling of the hand soap. Ultimately less sorbitol is needed to achieve the ‘correct’ hand feel of a common liquid soap. The ratio of glycerin to sorbitol is a 6:1 to 12:1 or 9:1 ratio which was the optimized minimum value from this study.

In formulating the soap mixture, the soap chips may be combined with one or more humectants. Suitable humectants include but are not limited to polyols such as glycerol sorbitol, propylene glycol and polyethylene glycols. In some embodiments, the humectants are glycerol and an additional humectant. In certain embodiments, the additional humectant is sorbitol. When the composition specifies glycerol and a humectant, the composition will comprise glycerol and a humectant that is other than glycerol.

In some embodiments, the soap making device 100 may contain liquid reservoirs and one or more ingredients reservoirs. In certain embodiments the one or more ingredients reservoirs may comprise about 87 wt % to about 91 wt % of glycerin; about 7 wt % to about 12 wt % of sorbitol; about 2 wt % to about 4 wt % of a preserving agent; and about 0 wt % to about 2 wt % of fragrance. In other embodiments, the ingredients reservoirs may comprise about 88 wt % to about 90 wt % of glycerin; about 8 wt % to about 11 wt % of sorbitol; about 2.5 wt % to about 3.5 wt % of a preserving agent; and about 0.5 wt % to about 1.5 wt % of fragrance.

Any suitable preserving agent may be used with the invention. Some preserving agents that may be used in the invention are surfactants. One preserving agent is a liquid growth inhibitor known as Leucidal® Complete and marketed by Active Micro Technologies.

The soaps made by the present invention may also comprise one or more colorants or dyes. Any suitable colorant may be utilized to obtain the desired color. Fragrances may also be utilized in the present invention. Any suitable fragrance may be included in an ingredients reservoir and may be included in a soap product of the invention.

Liquid soaps made in the device have the potential to grow microorganisms because of the high water content. To help maintain a sanitized soap solution, a concentration from about 2 wt % to about 4 wt % of a broad-spectrum preservative, such as, e.g., Leucidal® Complete, may be included in the additive phase with the glycerin/sorbitol solution or other additive solution.

Additionally, UV sterilization may be useful for sanitation. The major contributor to bacterial count in these products may come from the tap water which will be used in the process. Because of the many sources for harmful bacteria around the home, the device design can allow for the inclusion of UV sterilization of the mixing vessel contents. In some embodiments, sterilization will occur at the time that additives are added into the mixing vessel. In certain embodiments, sterilization will take place above 90° C.

The soap making device 100 may comprise an electrical operation system comprising the power on/off button, and the plurality of device settings buttons, operably connected with a printed circuit board, and a motor, an air pump, a heater 1300, and a water pump. The printed circuit board may contain a central processing unit (CPU). In some embodiments, the CPU performs one or more of interacting with a user interface to control the soap making process and to receive system updates remotely.

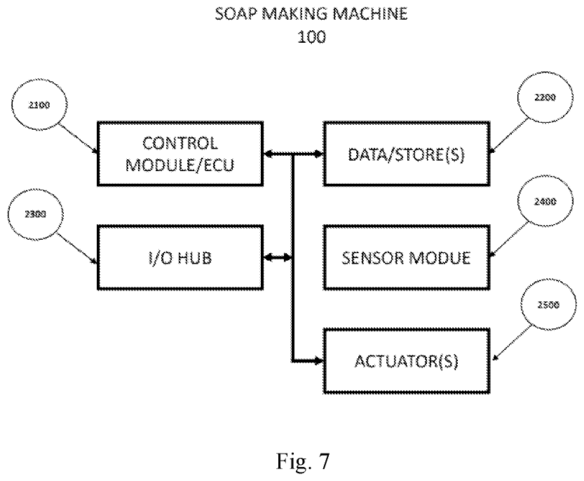

As shown in FIG. 7, the soap making device 100 may comprise a control module/electronic control unit (ECU) 2100, one or more data stores 2200, an I/O hub 2300, a sensor module 2400, and one or more actuators 2500. The control module may comprise a processor. As set forth, described, and/or illustrated herein, “processor” or “processing unit” means any component or group of components that are configured to execute any of the processes described herein or any form of instructions to carry out such processes or cause such processes to be performed. The one or more processors may be implemented with one or more general-purpose and/or one or more special-purpose processors. Examples of suitable processors include graphics processors, microprocessors, microcontrollers, digital signal processor (DSP) processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors may comprise at least one hardware circuit (e.g., an integrated circuit) configured to carry out instructions contained in program code. In embodiments in which there is a plurality of processors, such processors may work independently from each other, or one or more processors may work in combination with each other. In one or more embodiments, the one or more processors may be a host, main, or primary processor of the soap making device 100.

In some embodiments, combining FIGS. 1-6 with FIG. 7, the soap making device 100 comprises: (i) a top module 200 for receiving soap parts; (ii) producing soap chips using a means for increasing the surface area 1800 of the soap parts, the means for increasing surface area 1800 in communication with the top module 200; (iii) mixing vessel 450 within the mixing module 400 for receiving soap chips and forming a liquid soap mixture; (iv) means of agitation 1750 in the mixing vessel 450; (v) a first ingredients reservoir 1000 in fluid communication with the mixing vessel 450; (vi) a second ingredients reservoir 1100 in fluid communication with the mixing vessel 450; (vii) a control module 2100 having one or more processors; and (viii) a non-transitory memory or data store(s) 2200 operatively coupled to the one or more processors comprising a set of instructions executable by the one or more processors 2600 to cause the one or more processors to control one or more soap making device 100 functions.

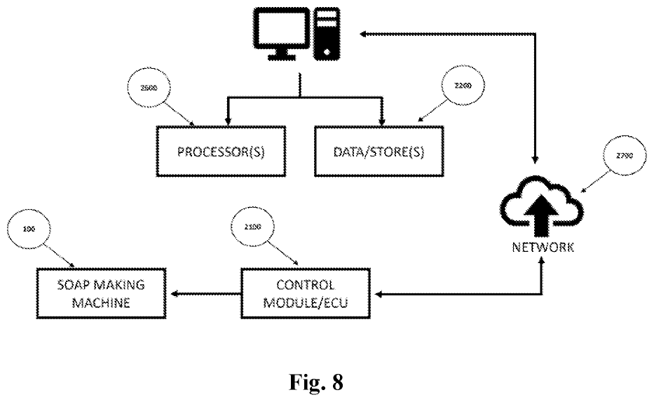

As depicted in FIG. 8, the control module/electronic control unit (ECU) 2100 may be configured to receive and transmit one or more data signals via a wireless network 2700. The wireless network 2700 may be configured to facilitate wireless communication between the soap making device 100 and one or more external source devices, such as one or more network server computers 2800 having one or more processors 2600 and one or more data stores 2200. In one or more embodiments, the one or more processors 2600 includes one or more processor cores to process instructions which, when executed, perform operations for system or user software. In some embodiments, the wireless network may be used to facilitate system or software updates. In one or more embodiments, the one or more processors 2600 includes one or more graphics processors to perform graphics processing operations.

In one or more example embodiments, the control module/electronic control unit (ECU) 2100 may communicate, via a network controller, with a wireless PAN (WPAN) (such as, for example, a BLUETOOTH WPAN), a WI-FI network, a WI-MAX network, a cellular telephone network (such as, for example, a Global System for Mobile Communications (GSM) network), or a combination thereof. Embodiments, however, are not limited thereto, and thus, this disclosure contemplates any suitable other suitable wireless network architecture that permits practice of the one or more embodiments.

Wireless network data comprises data communicated to one or more of the soap making device 100 and the one or more network server computers 2800 that is sourced from external sources. Accordingly, the control module/ECU 2100 may be configured to receive information from one or more other external source devices to the and process the received information.

The soap making device comprises non-transitory memory operatively coupled to the one or more processors comprising a set of instructions executable by the one or more processors 2600 to cause the one or more processors 2600 to control one or more of the hopper, the means for increasing surface area, the mixing vessel, the means for agitation, and the ingredients reservoir.

The one or more data stores 2200 are configured to store one or more types of data. The soap making device 100 may include interfaces that enable one or more systems thereof to manage, retrieve, modify, add, or delete, the data stored in the data stores 2200. The one or more data stores 2200 may comprise volatile and/or non-volatile memory. Examples of suitable data stores 2200 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 2200 may be a component of the processors of the control module/ECU 2100, or alternatively, may be operatively connected to the processors for use thereby. As set forth, described, and/or illustrated herein, “operatively connected” may include direct or indirect connections, including connections without direct physical contact.

The I/O hub 2300 is operatively connected to other systems and subsystems of the soap making device 100. The I/O hub 2300 may comprise an input interface and an output interface. The input interface and the output interface may be integrated as a single, unitary interface, or alternatively, be separate as independent interfaces that are operatively connected.

In one or more embodiments, the input interface may be used by an operator of the soap making device 100 to activate the making of a soap bar or liquid soap. The interface may activate dispensing of the liquid soap or ejection of the formed soap bar or the cleaning of the soap making device 100. The input interface may also allow the user to request or receive any system updates that are pushed out remotely.

The output interface is defined herein as any device, component, system, subsystem, element, or arrangement or groups thereof that enable information/data to be presented to a soap making device 100 operator. The output interface may be configured to present information/data to the soap making machine operator. The output interface may comprise one or more of a visual display, microphone and/or speaker.

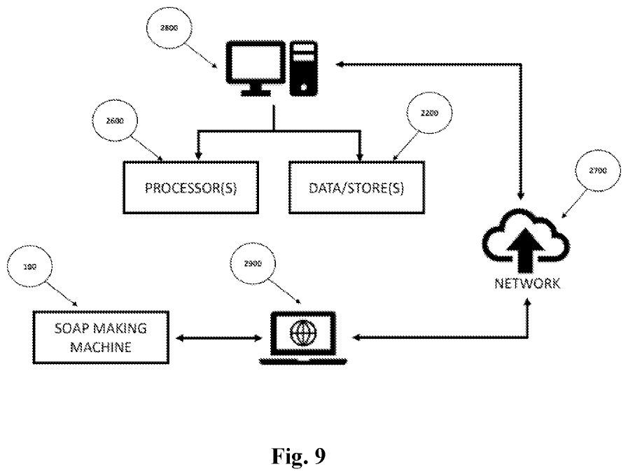

As illustrated in FIG. 9, the soap making device 100 may interface with a computing device 2900. In one or more embodiments, the computing device 2900 includes a computer, workstation, console, cellular phone, mobile device, or any other electronic, microelectronic, or microelectromechanical device for processing and communicating data. These communications may concern, among other things, software updates or import/export of soap recipes. Embodiments, however, are not limited thereto. This disclosure contemplates the computing device 2900 comprising any suitable architecture that permits practice of the one or more embodiments.

The soap machine, in some embodiments, may have a volumetric size of less than 1 cubic foot, weigh 40 lbs or less and have an external temperature of 120° F. or less. It is desirable that the machine have a sensor feature for dispensing liquid soap. In addition, it is desirable that the soap machine provide a warning if the amount of any soap component is too low for proper function of the machine.

In summary, in an exemplary embodiment the present invention may provide a tabletop electrical device which converts soap parts into a bar of soap or liquid soap. The device may save time by allowing the owner of the device to perform other tasks while the melting, mixing, and molding processes are performed automatically. The device may also save the user from having to understand the chemistry of soap making and needing a level of skill to make a bar or liquid soap.

For clarity, only those aspects of the system germane to the invention are described, and product details well known in the art are omitted. In addition, many embodiments of the present invention have application to a wide range of industries. To the extent the present application discloses a system, the method implemented by that system is within the scope of the present invention. Further, to the extent the present application discloses a method, a system of apparatuses configured to implement the method are within the scope of the present invention.

Further, the disclosure comprises additional notes and examples as detailed below.

Clause 1. A device for converting soap parts into bar soap or liquid soap mixture, the device comprising:

a hopper for receiving the soap parts;

means for increasing surface area of the soap parts by producing soap chips, the means for increasing the surface area being in communication with the hopper and at least some of the soap chips being smaller in size than the soap parts;

mixing vessel for receiving the soap chips and forming a liquid soap mixture, the mixing vessel comprising a means of agitation;

liquid reservoir in fluid communication with the mixing vessel;

ingredients reservoir in fluid communication with the mixing vessel;

a control unit having one or more processors; and

a non-transitory memory operatively coupled to the one or more processors comprising a set of instructions executable by the one or more processors to cause the one or more processors to control one or more of the hopper, the means for increasing surface area, the mixing vessel, the means for agitation, and the ingredients reservoir.

Clause 2. The device of clause 1, further comprising at least one of a bar soap mold and a bar soap discharge area.

Clause 3. The device of clause 1 or clause 2, further comprising a liquid soap mixture dispenser.

Clause 4. The device of any one of clauses 1-3, further comprising a bar soap mold, a bar soap discharge area and a liquid soap mixture dispenser.

Clause 5. The device of any one of clauses 1-4, wherein the means of agitation is a mixing arm or ultrasound.

Clause 6. The device of any one of clauses 1-5, wherein the means for increasing the surface area comprises at least one of a die and a blade array, a chopper, a shredder, and a grinder.

Clause 7. The device of any one of clauses 1-6, further comprising a device cleaning solution reservoir in fluid communication with means for increasing surface area of the soap parts.

Clause 8. The device of any one of clauses 1-7, wherein at least one of the mixing vessel or the liquid reservoir comprises a heater that heats contents of at least one of the mixing vessel or liquid reservoir.

Clause 9. The device of any one of clauses 1-8, further comprising one or more pumps to move one or more of liquid from the liquid reservoir to the mixing vessel, ingredients from the ingredients reservoir to the mixing vessel, and contents from the mixing vessel.

Clause 10. The device of any one of clauses 1-9, further comprising a user interface screen in electrical communication with the control unit that controls at least one of flow from the liquid reservoir to the mixing tank, flow from ingredients reservoir to the mixing tank, the grinder, a heater, and flow from the mixing tank to the bar soap mold.

Clause 11. A method of forming a bar of soap from soap parts in a device, the method comprising:

by the device, grinding, cutting, or shredding the soap parts to produce soap chips;

by the device, contacting the soap chips with a predetermined amount of glycerin and a humectant other than glycerin to produce a soap mixture;

by the device, mixing and heating the soap mixture to produce a blended soap mixture; and

by the device, heating, compressing, and molding the blended soap mixture into a soap bar,

wherein the soap mixture comprises about 28 wt % to about 96 wt % soap and about 0 to about 70 wt % glycerin.

Clause 12. The method of clause 11, the soap mixture comprises about 50 wt % to about 96 wt % soap and about 1 to about 10 wt % glycerin.

Clause 13. The method of clause 11 or clause 12, further comprising adding at least water to the soap mixture.

Clause 14. The method of any one of clauses 11-13, wherein the humectant other than glycerin is sorbitol.

Clause 15. The method of any one of clauses 11-14, wherein the heating is to a temperature of about 145° C. to about 175° C.

Clause 16. A method of forming liquid soap from soap parts in a device, the method comprising:

by the device, grinding, cutting, or shredding the soap parts to produce soap chips;

by the device, contacting the soap chips with a predetermined amount of water, glycerin, and humectant other than glycerin to produce an aqueous soap mixture;

by the device, heating the aqueous soap mixture; and

by the device, mixing the aqueous soap mixture to produce a blended soap mixture;

wherein the aqueous soap mixture comprises about 1 wt % to about 5 wt % soap chips, about 30 wt % to about 92 wt % water and about 0 wt % to about 60 wt % glycerin.

Clause 17. The method of clause 16, wherein the method utilizes about 3 wt % to about 5 wt % soap chips, about 70 wt % to about 95 wt % water and about 4 wt % to about 8 wt % glycerin.

Clause 18. The method of clause 16 or clause 17, wherein heating the soap mixture is at a temperature of about 80° C. to about 100° C.

Clause 19. The method of any one of clauses 16-118, wherein the amount of water is about 90 to about 95 wt % of the blended soap mixture.

Clause 20. The method of any one of clauses 16-19, wherein the humectant other than glycerin is sorbitol.

Clause 21. A solution for combining with soap chips to form a soap mixture comprising:
about 87 wt % to about 91 wt % of glycerin;
about 7 wt % to about 12 wt % of humectant other than glycerin;
about 2 wt % to about 4 wt % of a preserving agent; and
about 0 wt % to about 2 wt % of fragrance.

Clause 22. The solution of clause 21 comprising
about 88 wt % to about 90 wt % of glycerin;
about 8 wt % to about 11 wt % of sorbitol;
about 2.5 wt % to about 3.5 wt % of a preserving agent; and
about 0.5 wt % to about 1.5 wt % of fragrance.

Clause 23. The solution of clause 21 or clause 22, wherein humectant other than glycerin is sorbitol

Clause 24. The solution of any one of clauses 21-23, wherein the preserving agent is a surfactant.

It should be understood, of course, that the foregoing relates to exemplary embodiments of the invention and that modifications may be made without departing from the spirit and scope of the present invention.

The phrase “fluid communication” refers to the passage of a liquid from one component to another component. In general, the term communication refers to transfer of material from one element to another.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

When values are expressed as approximations, by use of the antecedent “about,” it will be understood that the particular value forms another embodiment. All ranges are inclusive and combinable. In addition, when a range is recited, it is contemplated that all values within the range, including endpoints, are combinable in all possible combinations.

As used herein, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value.

Throughout the description and claims of this specification, the words “comprise” and “contain” and variations of the words, for example “comprising” and “comprises,” mean “including but not limited to,” and are not intended to (and do not) exclude other components.

What is claimed:

1. A device for converting soap parts into bar soap or liquid soap mixture, the device comprising:
a hopper for receiving the soap parts;
means for increasing surface area of the soap parts by producing soap chips, the means for increasing the surface area being in communication with the hopper and at least some of the soap chips being smaller in size than the soap parts;
mixing vessel for receiving the soap chips and forming a liquid soap mixture, the mixing vessel comprising a means of agitation;
liquid reservoir in fluid communication with the mixing vessel;
ingredients reservoir in fluid communication with the mixing vessel;
a control unit having one or more processors; and
a non-transitory memory operatively coupled to the one or more processors comprising a set of instructions executable by the one or more processors to cause the one or more processors to control one or more of the hopper, the means for increasing surface area, the mixing vessel, the means for agitation, and the ingredients reservoir.

2. The device of claim 1, further comprising at least one of a bar soap mold and a bar soap discharge area.

3. The device of claim 1, further comprising a liquid soap mixture dispenser.

4. The device of claim 1, further comprising a bar soap mold, a bar soap discharge area and a liquid soap mixture dispenser.

5. The device of claim 1, wherein the means of agitation is a mixing arm or ultrasound.

6. The device of claim 1, wherein the means for increasing the surface area comprises at least one of a die and a blade array, a chopper, a shredder, and a grinder.

7. The device of claim 1, further comprising a device cleaning solution reservoir in fluid communication with the means for increasing surface area of the soap parts.

8. The device of claim 1, wherein at least one of the mixing vessel or the liquid reservoir comprises a heater that heats contents of at least one of the mixing vessel or liquid reservoir.

9. The device of claim 1, further comprising one or more pumps to move one or more of liquid from the liquid reservoir to the mixing vessel, ingredients from the ingredients reservoir to the mixing vessel, and contents from the mixing vessel.

10. The device of claim 1, further comprising a user interface screen in electrical communication with the control unit that controls at least one of flow from the liquid reservoir to the mixing tank, flow from ingredients reservoir to the mixing tank, the grinder, a heater, and flow from the mixing tank to the bar soap mold.

11. A method of forming a bar of soap from soap parts in a device, the method comprising:
by the device, grinding, cutting, or shredding the soap parts to produce soap chips;
by the device, contacting the soap chips with a predetermined amount of glycerin and a humectant other than glycerin to produce a soap mixture;
by the device, mixing and heating the soap mixture to produce a blended soap mixture; and
by the device, heating, compressing, and molding the blended soap mixture into a soap bar, wherein the soap mixture comprises about 28 wt % to about 96 wt % soap and about 0 to about 70 wt % glycerin.

12. The method of claim 11, wherein the soap mixture comprises about 50 wt % to about 96 wt % soap and about 1 to about 10 wt % glycerin.

13. The method of claim 11, further comprising adding at least water to the soap mixture.

14. The method of claim 11, wherein the heating is to a temperature of about 145° C. to about 175° C.

15. A method of forming liquid soap from soap parts in a device, the method comprising:
by the device, grinding, cutting, or shredding the soap parts to produce soap chips;
by the device, contacting the soap chips with a predetermined amount of water, glycerin, and humectant other than glycerin to produce an aqueous soap mixture;
by the device, heating the aqueous soap mixture; and
by the device, mixing the aqueous soap mixture to produce a blended soap mixture;
wherein the aqueous soap mixture comprises about 1 wt % to about 5 wt % soap chips, about 30 wt % to about 92 wt % water and about 0 wt % to about 60 wt % glycerin.

16. The method of claim 15, wherein the method utilizes about 3 wt % to about 5 wt % soap chips, about 70 wt % to about 95 wt % water and about 4 wt % to about 8 wt % glycerin.

17. The method of claim 15, wherein heating the soap mixture is at a temperature of about 80° C. to about 100° C.

18. The method of claim 15, wherein the amount of water is about 90 to about 95 wt % of the blended soap mixture.

19. A solution for combining with soap chips to form a soap mixture comprising:
about 87 wt % to about 91 wt % of glycerin;
about 7 wt % to about 12 wt % of sorbitol;
about 2 wt % to about 4 wt % of a preserving agent; and
about 0 wt % to about 2 wt % of fragrance.

20. The solution of claim 19, wherein the preserving agent is a surfactant.
